(19) United States
(12) Patent Application Publication
(10) Pub. No.: US 2010/0086712 A1
(43) Pub. Date: Apr. 8, 2010

(54) RADIATION-CROSSLINKING HOT-MELT ADHESIVE

(76) Inventors: THOMAS MOLLER, Dusseldorf (DE); Volker Erb, Duesseldorf (DE); Melanie Lack, Duesseldorf (DE)

Correspondence Address: Henkel Corporation, 10 Finderne Avenue, Bridgewater, NJ, 08807, US

(21) Appl. No.: 12/569,309

(22) Filed: Sep. 29, 2009

Related U.S. Application Data
(63) Continuation of application No. PCT/EP2007/063276, filed on Dec. 4, 2007.

(30) Foreign Application Priority Data
Mar. 30, 2007 (DE) 10 2007 015 801.9

(51) Int. Cl. C08G 18/30; C08F 2/50; B65B 53/00

(52) U.S. Cl. 428/34.9; 522/68; 522/30

(57) ABSTRACT

A radiation curable hot-melt adhesive is provided which contains a polyurethane polymer. This polyurethane polymer is prepared from A) a reactive polyurethane prepolymer which contains at least two NCO groups, B) a low molecular weight compound which comprises a free-radically polymerizable double bond and a functional group which reacts with a NCO group; C) a compound which comprises a functional group which reacts with a NCO group, but does not comprise a functional group polymerizable under free-radical condition; and D) a free-radical photoinitiator which contains a primary or secondary alcohol functional group. The radiation curable hot-melt adhesive is suitable as tapes, films, labels or articles for medical use with pressure-sensitively adhesive layers, in particular, for adhesively bonding shrinkable labels on rotationally symmetrical containers.

### CROSS REFERENCE TO RELATED APPLICATIONS

This application is a continuation of PCT/EP2007/063276 filed Dec. 4, 2007, which claims the benefit of DE 10 2007 015 801.9, filed Mar. 30, 2007, the complete disclosures of which are hereby incorporated.

### FIELD OF INVENTION

The invention relates to radiation-crosslinking hot-melt adhesives based on reactive polyurethanes, which may for example be used for adhesively bonding labels to containers, such as bottles, cans or cartons.

### BACKGROUND

Radiation-curing adhesives are generally known. Flowable, frequently low-viscosity adhesives are here for example crosslinked by free-radical or cationic polymerization and pressure-sensitive adhesives or solid adhesively bonded layers are obtained. The polymers must be adapted to the substrate surfaces in order to ensure good adhesion.

One particular area of application are adhesives for adhesively bonding plastics labels onto packaging, for example bottles or cans. Sleeve-type shrink labels are frequently used in order to ensure good adhesion to the substrate. Machinery and methods are known for applying such wrap-around labels onto rotationally symmetrical objects. These involve annular labels made from one or more films which are laminated to one another and are adjusted to a circumference greater than the item to be labeled, are slipped over said item and thereafter applied to the surface of the item by elastic recovery (stretch labels) or by thermal shrinkage (shrink labels).

Radiation-curing hot-melt adhesives are known for example from DE 4041753 A1 or WO 02/34858. Urethane-based coating compositions which are polymerizable in two stages are described therein, which in a first curing stage are solidified by a content of UV-polymerizable acrylate groups, and, in a subsequent second stage, are irreversibly crosslinked by isocyanate groups. Monofunctional acrylates are added to the adhesive as reactive diluents to reduce viscosity. Adhesives containing isocyanates may, however, be harmful to health.

JP 07088958 describes a method in which a polyolefin film is optionally printed and is adhesively bonded in tube form with electron beam-curing adhesives. No further details are provided regarding the adhesive. The tube materials are rolled up. EP 1130070 A1 describes radiation-induced curing adhesives which are synthesized on the basis of epoxidized block copolymers. These are capable of crosslinking on irradiation and are used for adhesively bonding shrink films.

UV-crosslinking adhesives are also known from WO 2005/105857, which describes reaction products prepared from a polyester diol, a polyether polyol together with an OH-functional acrylate, which are reacted with polyisocyanates. These prepolymers are then mixed with monomeric acrylates and initiators and used as a reactive adhesive.

Known adhesives, however, have the disadvantage that crosslinking and adhesion are not sufficiently rapidly obtained, and adhesion to plastics substrates is moreover frequently inadequate at elevated temperature and under mechanical stress.

### SUMMARY OF THE INVENTION

It is accordingly an object of the present invention to provide a method for adhesively bonding film labels with radiation-crosslinking hot-melt adhesives, together with a radiation-curable adhesive suitable for this purpose, the adhesive bond permitting rapid loading after crosslinking even when exposed to elevated temperatures and being distinguished by good adhesion to plastics surfaces. The adhesive is in particular suitable for adhesively bonding shrink labels for rotationally symmetrical containers.

Said object is achieved by the provision of a radiation-crosslinking hot-melt adhesive according to the claims. A hot-melt adhesive is here provided which contains a polyurethane polymer which contains at least one radiation-crosslinkable group, the polyurethane polymer being produced from a reactive polyurethane prepolymer with at least two NCO groups, a proportion of the NCO groups being reacted with low molecular weight compounds which contain free-radically crosslinkable double bonds together with a group reactive towards NCO groups, and a proportion of the NCO groups being reacted with monofunctional compounds which comprise no further free-radically crosslinkable groups. The hot-melt adhesive additionally contains at least one free-radical photoinitiator which is present either mixed into the polymer and/or attached by reaction to a proportion of the NCO groups.

The present invention also provides the use of such hot-melt adhesives with radiation-crosslinking functional groups, which are suitable for adhesively bonding film labels to containers, in particular for adhesively bonding shrinkable labels. The present invention also provides the use of such hot-melt adhesives for coating tapes, films, labels or articles for medical use with pressure-sensitively adhesive layers.

### DETAILED DESCRIPTION OF THE INVENTION

The hot-melt adhesive according to the invention substantially consists of a PU polymer which comprises terminal radiation-crosslinking reactive double bonds. The PU polymer should furthermore comprise free, non-crosslinkable polymer chain ends. The PU polymer may additionally comprise initiators chemically bonded thereto. The PU polymer is intended to be produced from an NCO-reactive polyurethane prepolymer.

The polyurethane prepolymer A) as the basis for the further reactions is produced by reacting diols and/or triols with di- or tri-isocyanate compounds. The quantity ratios are here selected such that terminally NCO-functionalized prepolymers are obtained. In particular, the prepolymers should be linear, i.e. predominantly produced from diols and diisocyanates. Small proportions of trifunctional polyols or isocyanates may additionally be used. The polyols and polyisocyanates usable in the synthesis of the prepolymers are known to a person skilled in the art.

These are the monomeric di- or triisocyanates known for adhesive applications. Examples of suitable monomeric polyisocyanates are 1,5-naphthylene diisocyanate, 2,2′-, 2,4- and/or 4,4′-diphenylmethane diisocyanate (MDI), hydrogenated MDI (H12MDI), allophanates of MDI, xylylene diisocyanate (XDI), tetramethylxylylene diisocyanate (TMXDI), 4,4′-diphenyldimethylmethane diisocyanate, di- and tetraalkylene diphenylmethane diisocyanate, 4,4′-dibenzyl diisocyanate, 1,3-phenylene diisocyanate, 1,4-phenylene diisocyanate, the isomers of tolylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4′-diisocyanatophenylperfluorethane, tetramethoxybutane 1,4-diisocyanate, butane 1,4-diisocyanate, hexane 1,6-diisocyanate (HDI), dicyclohexylmethane diisocyanate, cyclohexane 1,4-diisocyanate, ethylene diisocyanate, phthalic acid bis-isocyanatoethyl ester, trimethylhexamethylene diisocyanate, 1,4-diisocyanatobutane, 1,12-diisocyanatododecane, dimer fatty acid diisocyanate. Aliphatic isocyanates are particularly suitable, such as hexamethylene diisocyanate, undecane, dodecamethylene diisocyanate, 2,2,4-trimethylhexane-2,3,3-trimethyl-hexamethylene, 1,3- or 1,4-cyclohexane diisocyanate, 1,3- or 1,4-tetramethylxylene diisocyanate, isophorone diisocyanate, 4,4-dicyclohexylmethane, lysine ester diisocyanate or tetramethylxylylene diisocyanate (TMXDI).

Suitable trifunctional isocyanates are polyisocyanates which are obtained by trimerization or oligomerization of diisocyanates or by reaction of diisocyanates with polyfunctional compounds containing hydroxyl or amino groups. Isocyanates suitable for producing trimers are the diisocyanates which have already been mentioned above, the trimerization products of HDI, TMXDI or IPDI being particularly preferred.

In one particular embodiment, polyisocyanates with a uretidione, isocyanurate, allophanate, biuret, iminooxathiazinedione and/or oxadiazinetrione structure may be present.

The proportion of aromatic isocyanates should preferably be less than 50% of the isocyanates. Particularly preferred PU prepolymers are those based on aliphatic or cycloaliphatic polyisocyanates or oligomers based on HDI, IPDI and/or 2,4′- or 4,4′-diisocyanatod icyclohexylmethane.

Known polyols with a molecular weight of up to 50,000 g/mol may be selected as difunctional or trifunctional polyols. They should for example be selected on the basis of polyethers, polyesters, polyolefins, polyacrylates or polyamides, it being necessary for these polymers additionally to comprise OH groups. Polyols which comprise terminal OH groups are preferred.

Polyesters which are suitable for the purposes of the present invention as the polyol for producing the PU prepolymer may be obtained by polycondensation of acid and alcohol components, in particular by polycondensation of a polycarboxylic acid or of a mixture of two or more polycarboxylic acids and a polyol or a mixture of two or more polyols. Polycarboxylic acids with an aliphatic, cycloaliphatic, aromatic or heterocyclic parent substance are suitable as the polycarboxylic acid. Instead of the free carboxylic acids, it is optionally also possible to use the acid anhydrides thereof or the esters thereof with C₁₋₅ monoalcohols for polycondensation.

A plurality of polyols may be used as diols for reaction with the polycarboxylic acids. Aliphatic polyols with 2 to 4 primary or secondary OH groups per molecule and 2 to 20 C atoms are suitable, for example. A proportion of more highly functional alcohols may likewise be used. Methods for producing such polyester polyols are known to a person skilled in the art and these products are commercially obtainable.

Polyether polyols may furthermore be used as the polyol. Polyether polyols are preferably obtained by reacting low molecular weight polyols with alkylene oxides. The alkylene oxides preferably comprise two to four C atoms. The reaction products of ethylene glycol, propylene glycol or the isomeric butanediols with ethylene oxide, propylene oxide or butylene oxide are suitable, for example. Reaction products of polyfunctional alcohols such as glycerol, trimethylolethane or trimethylolpropane, pentaerythritol or sugar alcohols with the stated alkylene oxides to yield polyether polyols are also suitable. These may be random polymers or block copolymers. Particularly suitable polyether polyols obtainable from the stated reactions are those with a molecular weight of approx. 200 to approx. 20,000 g/mol, preferably of approx. 400 to approx. 6000 g/mol.

Polyacetals comprising terminal OH groups are likewise suitable as a polyol. Further polyols based on polycarbonates or polycaprolactones may be selected.

Further suitable polyols may be produced on the basis of polyacrylates. These comprise polymers produced by polymerization of poly(meth)acrylic esters. Small proportions of other copolymerizable monomers may optionally also be present. The acrylates according to the invention should comprise two OH groups. These may preferably be present terminally in the polymer. Such OH-functional poly(meth)acrylates are known to a person skilled in the art.

A further suitable class of polyols comprises OH-functionalized polyolefins. Polyolefins are known to a person skilled in the art and may be produced in many molecular masses. Such polyolefins based on ethylene, propylene or longer-chain α-olefins as homo- or copolymers may be functionalized either by copolymerization of monomers containing functional groups or by graft reactions. Another possibility involves subsequently providing said base polymers with OH-functional groups, for example by oxidation.

A further class of polyols contains a polyamide backbone. Polyamides are reaction products of diamines with di- or polycarboxylic acids. Terminal OH groups may be introduced into polyamides by targeted synthesis.

The polyols suitable according to the invention for producing the PU prepolymers should have a molar mass of between 200 and 50,000 g/mol. In particular, the molecular weight should be less than 30,000 g/mol. In the case of polyether polyols, the molecular weight should be between 200 and 20,000 g/mol, in particular between 400 and 6000 g/mol. In the case of polyester polyols, the molecular weight should preferably be below 10,000 g/mol, in particular between 600 and 2500 g/mol (number-average molecular weight, M_{N}, as may be determined by GPC). In particular, linear polyether polyols, polyester polyols or mixtures thereof are suitable.

The reaction of the polyols with the polyisocyanates may proceed, for example, in the presence of solvents, but solvent-free processing is preferred. The temperature is conventionally increased, for example to between 40 and 80° C., to accelerate the reaction. Catalysts conventional in polyurethane chemistry may optionally be added to the reaction mixture to accelerate the reaction. It is preferred to add dibutyltin dilaurate, dimethyltin dineodecanoate or diazabicyclooctane (DABCO). The quantity should here amount to from approx. 0.001 wt. % to approx. 0.1 wt. % of the prepolymer.

Prepolymers are preferably produced from the above-mentioned polyisocyanates and polyols based on polyether and/or polyester diols. In particular, mixtures of both types of polyol should be used in the synthesis, for example with a proportion of polyether polyol of 95 to 55 wt. %. A further particular embodiment uses polyether polyols which contain a proportion of ethylene oxide units of at least 50 wt. %. The resultant reactive PU prepolymers A) are NCO-reactive and bear 3 or preferably 2 isocyanate groups. These preferably comprise terminal NCO groups.

In a further reaction, a proportion of the NCO groups is reacted with compounds B) which bear a functional group which is capable of reacting with isocyanates and, as a further functional group, comprises a double bond crosslinkable by free-radical polymerization. These conventionally have a molecular weight of less than 1500 g/mol.

Examples of such compounds are esters of α,β-unsaturated carboxylic acids with low molecular weight, in particular aliphatic, alcohols which additionally bear a further OH group in the alkyl residue. Examples of such carboxylic acids are acrylic acid, methacrylic acid, crotonic acid, itaconic acid, fumaric acid semiester and maleic acid semiester. Corresponding OH group-bearing esters of (meth)acrylic acid are for example 2-hydroxyethyl(meth)acrylamide, 2-hydroxyethyl(meth)acrylate, 2-hydroxypropyl(meth)acrylate, 3-hydroxypropyl(meth)acrylate, 3-hydroxypropyl (meth)acrylamide, N-hydroxyethyl(meth)acrylamide, reaction products of glycidyl ethers or esters with acrylic or methacrylic acid, for example reaction products of versatic acid glycidyl esters with acrylic or methacrylic acid, adducts of ethylene oxide or propylene oxide onto (meth)acrylic acid, reaction products of hydroxyacrylates with ε-caprolactone or partial transesterification products of polyalcohols, such as pentaerythritol, glycerol or trimethyloipropane, with (meth)acrylic acid.

The quantity of the OH-functional compound with free-radically polymerizable double bonds is selected such that 20 to 95 mol % in particular 22 to 90 mol %, preferably 25 to 85 mol % are used relative to the NCO groups of the PU prepolymer. A preferred embodiment uses a mixture of methacrylates and acrylates, in which the proportion of acrylates constitutes at least 20 mol %, in particular at least 25 mol %, of the mixture.

The NCO-reactive PU prepolymer is furthermore reacted with at least one compound C) which comprises at least one isocyanate-reactive group and furthermore does not have a further group polymerizable under free-radical conditions. Examples of such isocyanate-reactive groups are OH, SH or NHR groups. These compounds C) should have a molar mass of between 32 and 10,000 g/mol, in particular between 40 and 4000 g/mol.

Suitable monofunctional compounds are for example alcohols with 1 to 36 C atoms, such as for example methanol, ethanol, propanol and higher homologs, together with the corresponding thio compounds. Monohydroxy- or monoamino-functional polymers with a molecular weight of less than 10,000 g/mol, in particular of 200 and 2000 g/mol, may furthermore also be used. Mixtures of low molecular weight and polymeric building blocks are also possible. The functional group should in particular be an OH group.

More highly functional compounds are also suitable. Examples of these are diols, triols or polyols, preferably diols or triols, in particular diols. Suitable compounds are for example polyols with 2 to 44 C atoms, for example ethylene glycol, propanediol, butanediol and higher homologs, together with the corresponding thio compounds. The quantities of these polyols are selected such that a suitable molar excess of this reactive functionality with regard to the NCO groups is present. The NCO prepolymers may be chain-extended, but preferably only one OH group should be reacted, and free OH groups are obtained. The molecular weight of this more highly functional compound C) should amount to up to 10,000 g/mol, in particular from 200 to 3000 g/mol. SH or NH polymers may also be used.

The quantity of the compound reactive with NCO groups is selected such that 1 to 50 mol % is converted relative to the NCO groups of the PU prepolymer. In one embodiment, the quantities are selected such that the sum of the monofunctional compound C) and the compound B) with the radiation-reactive groups together corresponds to the quantity of isocyanate groups. In a further preferred embodiment, difunctional NCO-reactive compounds are used, the quantity being selected such that the OH:NCO ratio amounts to 1.5 to 2.5:1, preferably to 1.6 to 2.2:1. In particular, the molar ratio should amount to 2:1, preferably as a difunctional hydroxyl compound.

The reaction methods for reacting the reactive PU prepolymers are known to a person skilled in the art. A reaction may here proceed in a mixture, or the constituents are reacted in succession. Randomly functionalized PU polymers are obtained after the reaction.

The PU polymer should have a molecular weight of less than 200,000 g/mol, in particular of between 1000 and 100,000 g/mol, preferably of between 2000 and 50,000 g/mol, in particular of below 20,000 g/mol. The PU polymer should contain substantially no isocyanate groups, i.e. only traces of unreacted NCO groups should remain after the reaction. The quantity should be less than 0.1% (relative to the prepolymer), particularly preferably less than 0.05%.

A photoinitiator which, on irradiation with light of a wavelength of approx. 215 nm to approx. 480 nm, is capable of initiating free-radical polymerization of olefinically unsaturated double bonds is used as a further necessary constituent of the hot-melt adhesive. For the purposes of the present invention, any conventional commercial photoinitiators are in principle suitable which are compatible with the hot-melt adhesive according to the invention, i.e. which provide at least largely homogeneous mixtures.

For example, these are any Norrish type I fragmenting and Norrish type II substances. Examples of these are photoinitiators of the Kayacure series (manufacturer Nippon Kayaku), Trigonal 14 (manufacturer: Akzo), photoinitiators of the Irgacure®, Darocure® series (manufacturer: Ciba-Geigy), Speedcure® series (manufacturer Lambson), Esacure series (manufacturer: Fratelli Lamberti) or Fi-4 (manufacturer Eastman). Of these, those which are in particular suitable are: Irgacure® 651, Irgacure® 369, Irgacure® 184, Irgacure® 907, Irgacure® 1850, Irgacure® 1173 (Darocure® 1173), Irgacure® 1116, Speedcure® EDB, Irgacure® 784 or Irgacure® 2959 or mixtures of two or more compounds from the group. Benzophenone and the derivatives thereof, such as Speedcure® MBP, Speedcure® MBB, Speedcure® BMS or Speedcure® BEM, thioxanthone and the derivatives thereof, such as Speedcure® ITX, Speedcure® CTX, Speedcure® DETX, 2,4,6-trimethylbenzenediphenylphosphine oxide, which may also be used as a mixture with one or more of the above-stated photoinitiators, are furthermore suitable.

The quantity of photoinitiators should amount to up to 6 wt. % relative to the adhesive, in particular to between 1 and 4 wt. %. In a preferred embodiment, the photoinitiators should initiate the reaction on exposure to UV-A radiation.

The hot-melt adhesive may additionally also contain proportions of reactive diluents. Suitable reactive diluents are in particular those compounds which comprise one or more functional groups which is/are reactive by irradiation with UV light or polymerizable with electron beam radiation.

Difunctional or more highly functional acrylate or methacrylate esters are in particular suitable. Such acrylate or methacrylate esters comprise for example esters of acrylic acid or methacrylic acid with aromatic, aliphatic or cycloaliphatic polyols or acrylate esters of polyether alcohols. Likewise suitable compounds are for example the acrylic acid or methacrylic acid esters of aromatic, cycloaliphatic, aliphatic, linear or branched C₄₋₂₀ monoalcohols or of corresponding ether alcohols. Examples of such compounds are 2-ethylhexyl acrylate, octyl/decyl acrylate, isobornyl acrylate, 3-methoxybutyl acrylate, 2-phenoxyethyl acrylate, benzyl acrylate or 2-methoxypropyl acrylate, neopentyl glycol di(meth)acrylate, 1,6-hexanediol di(meth)acrylate, trimethylolpropane tri(meth)acrylate, pentaerythritol tetra(meth)acrylate, and (meth)acrylate esters of sorbitol and other sugar alcohols. These (meth)acrylate esters of aliphatic or cycloaliphatic diols may optionally be modified with an aliphatic ester or an alkylene oxide. The acrylates modified by an aliphatic ester comprise for example neopentyl glycol hydroxypivalate di(meth)acrylate, caprolactone-modified neopentyl glycol hydroxypivalate di(meth)acrylates and the like. Alkylene oxide-modified acrylate compounds comprise for example ethylene oxide-modified neopentyl glycol di(meth)acrylates, propylene oxide-modified neopentyl glycol di(meth)acrylates, ethylene oxide-modified 1,6-hexanediol di(meth)acrylates or propylene oxide-modified 1,6-hexanediol di(meth)acrylates, neopentyl glycol-modified (meth)acrylates, trimethylolpropane di(meth)acrylates, polyethylene glycol di(meth)acrylates, polypropylene glycol di(meth)acrylates and the like. Trifunctional and more highly functional acrylate monomers comprise for example trimethylolpropane tri(meth)acrylate, pentaerythritol tri- and tetra(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, pentaerythritol tetra(meth)acrylate, tris[(meth)acryloxyethyl] isocyanurate, caprolactone-modified tris[(meth)acryloxyethyl] isocyanurate or trimethyloipropane tetra(meth)acrylate or mixtures of two or more thereof.

Auxiliary substances and additives which are additionally usable for the purposes of the present invention in the hot-melt adhesive include, for example, plasticizers, stabilizers, antioxidants, bonding agents, resins, polymers, dyes or fillers.

In one embodiment, the hot-melt adhesive according to the invention contains at least tackifying resin. The resin brings about additional tackiness. In principle any resin may be used which is compatible with the hot-melt adhesive, i.e. which forms a largely homogeneous mixture.

These in particular comprise resins which have a softening point of 70 to 140° C. (ring and ball method, DIN 52011). These are for example aromatic, aliphatic or cycloaliphatic hydrocarbon resins, together with modified or hydrogenated versions thereof. Examples are aliphatic or alicyclic petroleum hydrocarbon resins and the hydrogenated derivatives thereof. Further resins which may be used for the purposes of the invention are for example hydroabietyl alcohol and the esters thereof, in particular esters with aromatic carboxylic acids such as terephthalic acid and phthalic acid; modified natural resins such as resin acids from gum resin, tall oil resin or wood resin, for example partially or entirely saponified gum resin; alkyl esters of optionally partially hydrogenated rosin with low softening points, such as for example methyl, diethylene glycol, glycerol and pentaerythritol esters; terpene resins, in particular terpolymers or copolymers of terpene, such as styrene terpenes, α-methylstyrene terpenes, phenol-modified terpene resins and hydrogenated derivatives thereof; acrylic acid copolymers, preferably styrene-acrylic acid copolymers and resins based on functional hydrocarbon resins.

In a further embodiment, the resins comprise those types which are liquid at room temperature. Viscosity should preferably be below 1,000,000 mPa·s, in particular between 1000 and 200,000 mPa·s. Mixtures of solid and liquid resins are also possible.

The resins generally have a low molecular weight of below 1500 g/mol, in particular of below 1000 g/mol. They may be chemically inert or they still bear functional groups, such as double bonds or OH groups. In one embodiment, the functional groups do not react with the PU prepolymers according to the invention; in another embodiment, double bonds of the resin may react with the PU polymer. The resin may be used in a quantity of 0 to 70 wt. %, preferably of 10 to 40 wt. %, relative to the hot-melt adhesive.

The plasticizers used are for example medicinal white oils, naphthenic mineral oils, paraffinic hydrocarbon oils, phthalates, adipates, polypropylene, polybutene, polyisoprene oligomers, hydrogenated polyisoprene and/or polybutadiene oligomers, benzoate esters, plant or animal oils and the derivatives thereof. Usable stabilizers or antioxidants which may be selected are phenols, high molecular weight sterically hindered phenols, polyfunctional phenols, sulfur- and phosphorus-containing phenols or amines. Pigments which may be selected are for example titanium dioxide, talcum, clay and the like.

Waxes may optionally be added to the hot-melt adhesive. The quantity should be adjusted such that adhesion is not negatively affected. The wax may be of natural or synthetic origin.

Photosensitizers may furthermore additionally be used. By using photosensitizers, it is possible to extend the absorption of photopolymerization initiators to shorter and/or to longer wavelengths and, in this manner, to accelerate crosslinking. The radiation of a specific wavelength which they absorb is transferred as energy to the photopolymerization initiator. Photosensitizers which are usable for the purposes of the invention are for example acetophenone, thioxanthanes, benzophenone and fluorescein and the derivatives thereof.

The adhesives according to the invention may optionally comprise proportions of thermoplastic polymers, for example these may comprise polymers with a molecular weight of greater than 1000 g/mol. These do not contain any reactive groups; in another embodiment, these polymers may comprise vinylically unsaturated groups. These are for example polymers from the group of polyacrylates, polymethacrylates and the copolymers thereof, ethylene n-butyl acrylate copolymers, ethylene (meth)acrylic acid copolymers, ethylene vinyl acetate copolymers, polyvinyl methyl ether, polyvinylpyrrolidone, polyethyloxazolines, polyamides, starch or cellulose esters, amorphous polyolefins, for example polypropylene homopolymers, propylene butene copolymers, propylene hexene copolymers and in particular amorphous poly-alpha-olefin copolymers (APAOs), which are produced by metallocene catalysis.

These further polymeric constituents may be present in the hot-melt adhesive according to the invention in an amount of 0 to 30 wt. %, in particular of 2 to 20 wt. %. The molecular weight generally amounts to above 1000, preferably above 10,000 g/mol. The selection and characteristics of the thermoplastic polymers are known to a person skilled in the art.

The above-stated hot-melt adhesives are solvent-free and may be produced in known manner. They are suitable for the use according to the invention.

In one particular embodiment, a hot-melt adhesive according to the invention comprises a photoinitiator (D) which has at least one OH group reactive with NCO groups, for example a primary or secondary OH group. It is here advantageous if this OH group has reacted with a proportion of the NCO groups of the PU prepolymer and is present in polymer-bound form. The quantity of reactive initiators should amount to at least 1 mol % relative to the NCO groups of the PU prepolymer, in particular to between 4 and 50 mol %, preferably to between 10 and 30 mol %. The selected initiator is added during the course of the PU polymer synthesis, in which case the sum of components B, C, D should amount to 100 mol %.

In addition to the initiator attached by reaction, it is optionally possible for the hot-melt adhesive to contain up to 5 wt. %, in particular between 1 and 4 wt. %, of further unbound initiators. These may comprise an excess of the first initiator or other initiators may also be present. These may also exhibit different absorption behavior towards UV radiation.

The hot-melt adhesives according to the invention are in particular suitable for adhesively bonding labels to substrates made of glass, metal or plastics. Such labels may consist of coated or uncoated paper, but in particular of plastics. They may be ordinary or wrap-around labels. The hot-melt adhesives according to the invention are in particular distinguished by very good adhesion to the above-stated substrates.

A preferred application of the hot-melt adhesives which are suitable according to the invention is adhesively bonding labels, in particular heat-shrinkable labels, to hollow articles. Hollow articles are for example bottles, cans, lidded pails or cartridges. These may comprise rotationally symmetrical objects, but polygonal hollow articles are also possible. They consist for example of metal, glass or thermoplastics. Polar plastics containers, in particular made of polyester, may preferably be adhesively bonded. Such hollow articles are for example used for mineral water and soft drinks. The labels generally consist of thermoplastics such as polyethylene, polypropylene, polystyrene, polyvinyl chloride or cellulose film. It is preferred to use labels made from a film based on nonpolar plastics, in particular on oriented polypropylene (OPP). No particular requirements apply with regard to the shape of the labels. Preferably, however, they comprise wrap-around labels. For example, it is possible to adhesively bond labels for aerosol cans or contoured bottles with subsequent shrink fitting.

When using the hot-melt adhesives which are suitable according to the invention, these are applied in the molten state to the label, adhesively bonded in the following method step and thereafter radiation-crosslinked. If processing is to be unproblematic, the hot-melt adhesives according to the invention should have an appropriately low viscosity prior to irradiation which, at 130° C., should conventionally be 200 mPa·s to 10,000 mPa·s, in particular 500 mPa·s to 3000 mPa·s (measured with a Brookfield DV 2+ viscosimeter, spindle 27, at the stated temperature).

The hot-melt adhesives according to the invention exhibit the necessary low viscosity at low processing temperatures, as is for example desired for use on thermally sensitive labels, for example plastics labels made from OPP. Processing temperatures are in the range from 50° C. to 150° C., preferably in the range from 70° C. to 130° C. Processing proceeds on per se known machinery.

After application of the hot-melt adhesive according to the invention and joining together of the parts to be adhesively bonded, for example joining of the adhesively bonded labels or of the label to the hollow article, the hot-melt adhesive according to the invention is irradiated with a UV or electron beam radiation dose which is sufficient to ensure that the hot-melt adhesive has sufficient adhesion and connects the substrates. The duration of irradiation should here be less than 5 sec. On irradiation with UV radiation, it is preferred to use transparent labels or those which are at least UV-transmitting in the adhesion zone.

Thereafter, in the case of shrinkable labels, these are shrink-fitted onto the contour of, for example, an aerosol can, at temperatures of at least 120° C., usually of above 150° C. within a few seconds. In particular in the field of overlapping adhesive bonding, once irradiated with UV or electron beam radiation, the hot-melt adhesive according to the invention exhibits a very slight tendency to creep simultaneously combined with good adhesive strength of the overlapping adhesive bond. Moreover, the heat resistance of the hot-melt adhesive according to the invention is improved, no movement of the overlapping adhesively bonded labels being observed at elevated temperature, not even due to the change in shape brought about by shrink fitting. Problems, such as for example soiling due to an adhesive layer exposed by unintentional movement, are thus prevented. Such shrinkable sleeve-type labels may also be used as securing means for bottle screw closures.

Another type of use of the hot-melt adhesives suitable according to the invention is coating self-adhesive films, tapes or labels with an adhesive layer. Tapes or films, for example based on polyolefins or polyesters, are here coated with the hot-melt adhesive suitable according to the invention and the latter is crosslinked by radiation. In this case, a permanently pressure-sensitively adhesive layer is obtained by selection of an appropriate adhesive. These materials may then be converted. Permanently tacky films, labels and tapes may be produced in this manner. The resultant self-adhesive surfaces may optionally be covered with antiadhesively coated backing films. The coated labels or films exhibit elevated heat resistance once they have been adhesively bonded to a substrate. For example, such substrates may then be filled with heated contents without the adhesively bonded film or label becoming detached. In the case of coating such self-adhesive planar substrates, the viscosity on application of the uncrosslinked adhesives may be from 500 to 200,000 mPa·s at processing temperature, preferably from 5000 to 50,000 mPa·s, in particular up to 10,000 mPa·s. The suitable viscosity is dependent on the application method and may be selected accordingly by a person skilled in the art. The processing temperature may here, for example, be up to 130° C.

Another type of use is in the production of medical materials. For example, the adhesive faces of plasters or other self-adhesive substrates may be coated with an adhesive according to the invention. It is preferred for this intended application to use hot-melt adhesives which exhibit elevated water vapor permeability. For example, values of above 500 g/m² d, in particular of above 1000 g/m² d, may be obtained by selection of the components. In particular, hot-melt adhesives according to the invention which are suitable for this purpose are those which contain polyether polyols with an elevated proportion of ethylene oxide as the polyol component in the PU prepolymer A). The viscosity of the adhesives corresponds to adhesives for coating tapes or films. After UV crosslinking permanently pressure-sensitively adhesive layers are obtained.

The solvent-free hot-melt adhesives according to the invention exhibit improved adhesive strength after crosslinking. The resultant network is of uniform structure and improved adhesion and cohesion are obtained over a wide temperature range. It is furthermore advantageous that attachment of the initiators by chemical reaction means that the initiators cannot migrate into the substrate.

The Examples are intended to illustrate the subject matter of the invention in greater detail.

### EXAMPLES

### Example 1

Apparatus: 1 l four-necked flask with stirrer; temperature sensor; N₂ blanketing system; height adjustable oil bath; vacuum pump with nitrogen-filled cold trap

### Reaction Batch:

| | | |
|---|---|---|
| 1.) PPG 1000 | 300.00 g | (polypropylene glycol 1000; OH |
| | | value = 112) |
| 2.) IPDI | 78.46 g | (isophorone diisocyanate) |
| 3.) DBTL | 0.01 g | (dibutyltin dilaurate) |
| 4.) HEA | 3.24 g | (2-hydroxyethyl acrylate) |
| 5.) Irgacure 2959 | 12.53 g | (photoinitiator) |
| 6.) Polyglycol 01/40 | 30.72 g | (butyl-substituted PPG monoalcohol) |
| 7.) Irganox 1726 | 0.76 g | (antioxidant) |

### Experimental Procedure:

1.) was initially introduced and heated to approx. 120° C. A vacuum was then applied and the batch was dewatered for 1 h at <10 mbar and then ventilated with nitrogen. The temperature was lowered to 30° C., 3.) was added and homogenized for 10 min. 2.) was then added. The temperature was increased to 80° C. in steps. Stirring was continued at this temperature until the NCO value was 1.24%. The batch was ventilated, 0.38 g of 7.) was added and homogenized. 4.) was then added and stirring continued at 80° C. until an NCO value of 0.65% was measured. 5.) was added and stirring continued until the NCO value was 0.12%. 0.38 g of 7.) was stirred in. 6.) was added and stirring continued until the NCO value was less than 0.02%. The batch was degassed under a vacuum and packaged. Melt viscosity 1500 mPa·s at 120° C.; after 48 hours' storage at 120° C., the viscosity was 1400 mPa·s.

Peel test (ASTM D 1876): 2.3 N

### Test Method:

A stripe of an adhesive according to the invention is applied at approx. 120-130° C. onto one end of a transparent OPP film (Exxon Mobil 50 LR 210). This end is adhesively bonded onto a cleaned aluminum can. A stripe of the adhesive is then applied correspondingly onto the other side of the film and the overlap (approx. 1 cm) adhesively bonded. The labeled can is then irradiated at the adhesive seam with a Fusion F-600 UV installation with an H emitter (240 watt/cm) at a belt speed of 25 m/min. The distance from the substrate is 10 cm. The seam overlap is then marked, after which shrinkage is performed in a circulating air cabinet at 120° C. At constant time intervals (5 min), it is evaluated whether the adhesive is withstanding the forces arising in the shrinkage process. This may be established by slippage of the overlap mark.

If they are not subjected to immediate testing, the resultant test specimens should be stored in the dark.

The applied and tested adhesives according to Examples 1 to 5 all exhibit good resistance, the overlap does not slip after 30 minutes' exposure in the circulating air cabinet.

Tack +, adhesion +, creep ++

### Example 2

### Apparatus: as in Example 1

| | | |
|---|---|---|
| 1.) PPG 1000 | 300.00 g | |
| 2.) IPDI | 78.46 g | |
| 3.) Tinstab BL 277 | 0.01 g | (Sn catalyst) |
| 4.) HEA | 4.59 g | |
| 5.) Irgacure 2959 | 11.82 g | |
| 6.) Polyglycol B01/40 | 14.49 g | |
| 7.) Irganox 1726 | 0.76 g | |

### Experimental Procedure:

1.) was initially introduced and heated to approx. 120° C. A vacuum was then applied and the batch was dewatered for 1 h at <10 mbar and then ventilated with nitrogen. The temperature was lowered to 30° C., 3.) was added and homogenized for 10 min. [sic] was then added. The temperature was increased to 80° C. in steps. Once the NCO value had reached 1.17%, the apparatus was ventilated, 0.38 g of 7.) was added and homogenized. 4.) was then added and stirring continued until an NCO value of 0.72% was measured. 5.) was added and stirring continued until the NCO value was 0.12%. 6.) was stirred in and stirring continued until the NCO value was less than 0.05%. The batch was then degassed under a vacuum and packaged. Melt viscosity 3100 mPa·s at 120° C. After 48 hours' storage at 120° C., the viscosity was 3400 mPa·s.

Peel test: 1.7 N
Result according to the above-described test method: tack +, adhesion +, creep +

### Example 3

### Apparatus: as in Example 1

### Reaction Batch:

| | | |
|---|---|---|
| 1.) PPG 1000 | 50.00 g | |
| 2.) PE218 | 200.00 g | (aliphatic polyester diol, OH value 131, |
| | | molar weight approx. 850) |
| 3.) IPDI | 94.54 g | |
| 4.) Tinstab BL 277 | 0.01 g | |
| 5.) HEA | 14.76 g | |
| 6.) Irgacure 2959 | 28.51 g | |
| 7.) Irganox 1726 | 0.75 g | |

### Experimental Procedure:

1.)+2.) were initially introduced and heated to approx. 120° C. A vacuum was then applied and the batch was dewatered for 1 h at 13 mbar and then ventilated with nitrogen. The temperature was lowered to 63° C., 0.005 g of 4.) was added and homogenized for 5 min. 3.) was then added. The temperature rose from 56° C. to 74° C. Once the exothermic reaction had subsided, the temperature was raised to 90° C. with the oil bath and the batch stirred until the NCO value was 3.10%. The batch was then ventilated with dry air, 0.35 g of 7.) was added and homogenized. 5.) was then added and stirring continued. After 1 h, an NCO value of 1.59% was measured. 6.) was added and stirring continued until the NCO value was 0.17%. The batch was post-catalyzed with 0.005 g of 4.) and stirring continued until the NCO value was less than 0.1%. 0.39 g of 7.) was stirred in. The batch was then degassed under a vacuum for 0.5 h and packaged. Melt viscosity 1000 mPa·s at 125° C.

Result according to the above-described test method:
Tack +, adhesion +, creep +

### Example 4

### Apparatus: as in Example 1

### Reaction Batch:

| | | |
|---|---|---|
| 1.) Poly-G 55-112 | 240.00 g | (ethylene oxide/propylene oxide |
| | | diol, OH value = 112, molar |
| | | weight 1000) |
| 2.) PE218 | 60.4 g | |
| 3.) IPDI | 83.3 g | |
| 4.) DBTL | 0.01 g | |
| 5.) Irganox 1726 | 0.78 g | |
| 6.) HEA | 3.4 g | |
| 7.) Irgacure 2959 | 13.1 g | |
| 8.) Polyglycol B01/40 | 32.2 g | |

### Experimental Procedure:

1.)+2.) were initially introduced and heated to approx. 120° C., a vacuum was applied and the batch dewatered for 1 h at 16 mbar and then ventilated with nitrogen. 4.) was added and homogenized for 10 min, then 3.) was added. The temperature was slowly raised in 10° C. steps to 80° C. and stirring continued until the NCO value was 1.28%. The temperature was raised to 90° C., 0.38 g of 8.) was added and homogenized. 5.)+6.)+7.) were added and stirring was continued until the NCO value was below 0.05%. 0.40 g of 8.) was added and homogenized. The batch was then degassed under a vacuum and packaged. Melt viscosity 2900 mPa·s at 120° C.; after 4 days' storage at a temperature of 120° C., melt viscosity was 2300 mPa·s.

Result according to the described test method: tack +, adhesion +, creep +. The water vapor permeability of a 50 μm film at 40° C. is 2200 g/m² d (as per DIN 53122).

1. A radiation-crosslinkable hot-melt adhesive comprising at least 30 weight %, based on the adhesive, of a polyurethane polymer prepared from:
A) a reactive polyurethane prepolymer (A) which comprises at least two NCO groups per molecule prepared from the reaction of:
i) a di- or trifunctional polyol with a molar mass of 200 to 50,000 g/mol selected from the group consisting of polyethers, polyesters, polyolefins, polyacrylates, polyamides and mixtures thereof, and
ii) an excess of a di- or triisocyanate with a molar mass of below 1000 g/mol;
B) 20 to 95 mol % of a low molecular weight compound (B) which comprises a free-radically polymerizable double bond and a group which reacts with a NCO group;
C) 1 to 50 mol % of a compound (C) which comprises a group which reacts with a NCO group, but does not comprise a group polymerizable under free-radical conditions, and with a molar mass of 32 to 5000 g/mol; and
D) 5 to 50 mol % of a free-radical photoinitiator (D) which comprises a primary or a secondary OH group, and
in which the mol % values are stated in relation to the NCO groups of the polyurethane prepolymer (A), and in which the sum of the mol % of the groups which react with a NCO group on the B, C and D equals to 100 mol %.

2. The hot-melt adhesive of claim 1, wherein the hot-melt adhesive is substantially free of isocyanate groups.

3. The hot-melt adhesive of claim 1, wherein the di- or trifunctional polyol is a polyether, polyester diols or mixtures thereof, and has a molar mass of 200 to 20,000 g/mol.

4. The hot-melt adhesive of claim 3, wherein the polyester diols has an ethylene oxide content greater than 25 weight %.

5. The hot-melt adhesive of claim 1, wherein the di- or triisocyanate is an aliphatic isocyanate.

6. The hot-melt adhesive of claim 1, wherein the compound B is a OH-functional esters of (meth)acrylic acid.

7. The hot-melt adhesive of claim 1, wherein the adhesive comprises 2 to 35 mol % of the compound C and said compound C is a mono- or difunctional alcohol.

8. The hot-melt adhesive of claim 1, wherein the adhesive comprises 5 to 25 mol % of the photoinitiator and said photoinitiator comprise a primary OH group.

9. The hot-melt adhesive of claim 1 further comprising a thermoplastic polymer, wherein said thermoplastic polymer is a polyester, polyether, polyamide or polyolefin.

10. The hot-melt adhesive of claim 9, wherein the thermoplastic polymer further comprises a vinyl functional group.

11. The hot-melt adhesive of claim 1 further comprising an auxiliary, wherein the auxiliary is a resin, stabilizer, plasticizer or photoinitiator.

12. The hot-melt adhesive of claim 1, wherein the adhesive has a water vapor permeability of greater than 500 g/m² d.

13. The hot-melt adhesive of claim 1, wherein the viscosity of the adhesive is in the range of from 200 to 200,000 mPa·s at 130° C.

14. A polyurethane polymer prepared from:
A) a reactive polyurethane prepolymer (A) which comprises at least two NCO groups per molecule prepared from the reaction of:
i) a di- or trifunctional polyol with a molar mass of 200 to 50,000 g/mol selected from the group consisting of polyethers, polyesters, polyolefins, polyacrylates, polyamides and mixtures thereof, and
ii) an excess of a di- or triisocyanate with a molar mass of below 1000 g/mol;
B) 20 to 95 mol % of a low molecular weight compound (B) which comprises a free-radically polymerizable double bond and a group which reacts with a NCO group;
C) 1 to 50 mol % of a compound (C) which comprises a group which reacts with a NCO group, but does not comprise a group polymerizable under free-radical conditions, and with a molar mass of 32 to 5000 g/mol; and
D) 5 to 50 mol % of a free-radical photoinitiator (D) which comprises a primary or a secondary OH group, and
in which the mol % values are stated in relation to the NCO groups of the polyurethane prepolymer (A), and in which the sum of the mol % of the groups which react with a NCO group on the B, C and D equals to 100 mol %.

15. A hot melt adhesive comprising the polyurethane polymer of claim 14.

16. An article of manufacture comprising the adhesive of claim 1.

17. The article of claim 16 which is a pressure sensitive adhesive.

18. The article of claim 17 which is a tape, film, or a label.

19. The article of claim 18 which is a shrinkable label.

20. The article of claim 19 which is bonded to a rotationally symmetrical metal, glass or plastic container.
